(19) United States
(12) Patent Application Publication
(10) Pub. No.: US 2026/0365769 A1
(43) Pub. Date: Nov. 19, 2026

(54) HIGH-PRESSURE POLYMERIZATION PROCESS OF ETHYLENICALLY UNSATURATED MONOMERS

(71) Applicant: Basell Polyolefine GmbH, Wesseling (DE)

(72) Inventors: Danir Khayrullin, Frankfurt (DE); Juergen Mohrbutter, Frankfurt (DE); Christoph Wolf, Frankfurt (DE); Andre-Armand Finette, Frankfurt (DE); Michael Deuerling, Frankfurt (DE); Sven Wolfram, Frankfurt (DE)

(73) Assignee: Basell Polyolefine GmbH, Wesseling (DE)

(21) Appl. No.: 19/126,283

(22) PCT Filed: Nov. 1, 2023
(86) PCT No.: PCT/EP2023/080477

§ 371 Date: May 1, 2025

(30) Foreign Application Priority Data
Nov. 1, 2022 (EP) 22204853.0

(51) Int. Cl. C08F 220/16; B01J 19/00; B01J 19/18; C08F 2/34; C08F 2/44; C08F 10/02

(52) U.S. Cl. CPC C08F 220/16; B01J 19/006; B01J 19/0066; B01J 19/1812; C08F 2/34; C08F 2/44; C08F 10/02; B01J 2219/00033; B01J 2219/00162; B01J 2219/00353; C08F 2400/04

(57) ABSTRACT

A process for preparing ethylene polymer or ethylene copolymers in a high-pressure polymerization apparatus wherein one or more free-radical polymerization initiators are introduced into the high-pressure polymerization apparatus using a phased flow pump. A process for preparing ethylene polymers or ethylene copolymers in a high-pressure polymerization apparatus comprising a polymerization reactor being (a) a continuously operated autoclave reactor with a stirrer driven by an electrical motor or (b) a continuously operated tubular reactor, comprising the steps of: (i) compressing a reaction mixture comprising (a) ethylene or (b) ethylene and one or more comonomers, to a pressure of 110 MPa to 500 MPa in one or more compressors, to obtain a compressed process gas; (ii) feeding the compressed process gas into the polymerization reactor; (iii) introducing one or more free-radical polymerization initiators into the polymerization reactor; and (iv) polymerizing the ethylene or ethylene and one or more comonomers.

### FIELD OF DISCLOSURE

In general, the present disclosure relates to the field of chemistry. More specifically, the present disclosure relates to polymer chemistry. In particular, the present disclosure relates to a process for the preparation of ethylene polymer or ethylene copolymers in a high-pressure polymerization apparatus.

### BACKGROUND OF THE DISCLOSURE

In some instances, polyethylene is used in applications ranging from packaging to electrical insulation.

In some instances, polyethylene is produced by a number of different processes. In some instances, the process includes polymerization in the presence of free-radical initiators at elevated pressures. In some instances, the resulting polyethylene is a low-density polyethylene (LDPE).

In some instances, the set-up for preparing polyethylene includes a high-pressure polymerization reactor such as an autoclave or tubular reactor. In some instances, the reaction components are compressed using a set of two compressors, a primary and a secondary compressor. In some instances, the compressed reaction gas is pre-heated before entering the high-pressure reactor where polymerization takes place. In some instances and at the end of the polymerization sequence, the obtained polymer is then conveyed to a separator and passed on to an extruder or granulator of pelletizing the polymer. In some instances, the set-up provides for feeding monomers, comonomers, free-radical initiators and other substances at one or more positions to the polymerization reaction.

Some instances, the controlled injection of the reaction components into the process stream permits obtaining consistent, high quality products. In some instances, initiators are injected at precise volumetric or mass flow rates into relatively much larger flows or raw and intermediate products. In some instances, the initiators promote the chemical reactions and affect process parameters in process machinery and reaction vessels. In some instances, the process parameters are pressure and temperature.

### SUMMARY OF THE DISCLOSURE

In a general embodiment, the present disclosure provides a process for preparing ethylene polymers or ethylene copolymers in a high-pressure polymerization apparatus, including a polymerization reactor being (a) a continuously operated autoclave reactor with a stirrer driven by an electrical motor or (b) a continuously operated tubular reactor, including the steps of:
compressing a reaction mixture made from or containing (a) ethylene or (b) ethylene and one or more comonomers, to a pressure of 110 MPa to 500 MPa in one or more compressors, thereby obtaining compressed process gas;
feeding the compressed process gas into the polymerization reactor;
introducing one or more free-radical polymerization initiators into the polymerization reactor by a reciprocating phased flow pump with at least two heads, wherein each head having at least one cylinder, and being operable in a manner of overlapping strokes of cylinders of different pump heads; and
polymerizing the (a) ethylene or (b) ethylene and one or more comonomers, in the presence of the free-radical polymerization initiators at temperatures from 100 to 350 °C.

In some embodiments, at least part of the process gas is pre-mixed with the free-radical polymerization initiators prior to introducing the free-radical polymerization initiators into the polymerization reactor.

In some embodiments, the polymerization reactor has one or more reaction zones, alternatively at least two reaction zones, alternatively up to 6 reaction zones, alternatively 3 or 4 reaction zones.

In some embodiments, the polymerization reactor is an autoclave reactor and the reaction zones are defined by baffles attached to the stirrer.

In some embodiments, the pump is operated in a manner of overlapping strokes of cylinders of different pump heads.

In some embodiments, each head has an independent cylinder. In some embodiments, an independent cylinder refers to a cylinder that moves independently from the cylinders of the other heads. In other words, the motion of one cylinder is decoupled from the movement of the cylinder of the other heads.

In some embodiments, the phased flow pump has three heads and each head has at least one cylinder, alternatively exactly one cylinder. In some embodiments, the pump is configured such that the cylinders have alternating strokes. In other words, a first cylinder pushes forwards, then the second cylinder pushes forward, and then the third cylinder pushes forward, before the sequence begins again with the first cylinder.

In some embodiments, the cylinders of the pump heads are operated such that one cylinder starts moving forward, thereby increasing the pressure before the preceding cylinder has reached the end of the preceding cylinder's stroke and starts to decrease pressure.

In some embodiments, the cylinders operate in a suction stroke in which pressure inside the cylinder is reduced, initiator is sucked into the cylinder, or both, and in a discharge stroke, in which pressure inside the cylinder is increased, initiator is discharged out of the cylinder, or both, wherein the suction stroke is shorter than the discharge stroke.

In some embodiments, the suction stroke of the cylinders of one pump head finishes before the discharge stroke of the cylinders of another pump head.

In some embodiments, the process further includes the step of discharging the reaction mixture made from or containing (a) ethylene polymer and ethylene or (b) ethylene copolymer, ethylene and one or more comonomers, from the polymerization reactor.

In some embodiments, the process further includes a step of cooling the discharged reaction mixture.

In some embodiments, the process further includes the step of transferring the discharged reaction mixture to at least one product separator for separating the ethylene polymer or ethylene copolymer.

In some embodiments, the process further includes the step of converting the resulting ethylene polymer or ethylene copolymer into pellets.

In some embodiments, the comonomers are selected from the group consisting of α,β-unsaturated C₃-C₈-carboxylic acids, derivatives of α,β-unsaturated C₃-C₈-carboxylic acids, and 1-olefins. In some embodiment, the derivatives of α,β-unsaturated C₃-C₈-carboxylic acids are selected from the group consisting of unsaturated C₃-C₈-carboxylic esters and anhydrides. In some embodiments, the comonomers are vinyl carboxylates. In some embodiments, the vinyl carboxylate is vinyl acetate. In some embodiments, the 1-olefins are selected from the group consisting of propene, 1-butene, and 1-hexane. In some embodiments, the comonomers are selected from the group consisting of propene, 1-butene, 1-hexane, acrylic acid, n-butyl acrylate, ter-butyl acrylate, 2-ethylhexyl acrylate and vinyl propriate.

In some embodiments, the present disclosure provides a high-pressure polymerization apparatus for carrying out a process for preparing ethylene polymers or ethylene copolymers, including:
a compressor or a series of compressors for compressing a reaction mixture made from or containing (a) ethylene or (b) ethylene and one or more comonomers, to a pressure of 110 MPa to 500 MPa, thereby obtaining compressed process gas;
a polymerization reactor for polymerizing (a) ethylene or (b) ethylene and one or more comonomers, in the presence of one or more free-radical polymerization initiators at temperatures from 100 to 350 °C, being (a) a continuously operated autoclave reactor with a stirrer driven by an electrical motor or (b) a continuously operated tubular reactor;
at least one feedline for feeding the compressed process gas into the polymerization reactor; and
a reciprocating phased flow pump with at least two heads, wherein each head having at least one cylinder, for introducing the free-radical polymerization initiators into the polymerization reactor.

In some embodiments, the apparatus further includes:
a cooler for cooling a reaction mixture discharged from the autoclave reactor;
at least one separator for separating the ethylene polymer or ethylene copolymer; and
a pelletizer for converting the ethylene polymer or ethylene copolymer into pellets.

### BRIEF DESCRIPTION OF THE DRAWINGS

FIG. 1 is a schematic of a process for preparing ethylene polymers or ethylene copolymers in a high-pressure polymerization apparatus.

FIG. 2 is a schematic of a high-pressure polymerization apparatus for carrying out a process for preparing ethylene polymers or ethylene copolymers.

### DETAILED DESCRIPTION OF THE DISCLOSURE

As used herein, the term “reactor stability” refers to a stable operation achieved without interruption of the reaction, or having a stable temperature profile and no sudden thermal decomposition.

In some embodiments, the present disclosure provides a process for preparing ethylene polymers or ethylene copolymers in a high-pressure polymerization apparatus, including a polymerization reactor being (a) a continuously operated autoclave reactor with a stirrer driven by an electrical motor or (b) a continuously operated tubular reactor, with the free-radical initiators being introduced by a reciprocating pump with at least two heads, wherein each head having at least one cylinder.

In some embodiments, the polymerization is carried out in both an autoclave reactor and a tubular reactor. In some embodiments, the polymerization is carried out in a combination of an autoclave reactor and a tubular reactor arranged in series.

In some embodiments, the process gas made from or containing (a) ethylene or (b) ethylene and one or more comonomers, is compressed to a pressure of 110 MPa to 500 MPa, thereby obtaining compressed process gas. In some embodiments, the compression of the process gas to the polymerization pressure is carried out by one or more compressors in a sequence of compression stages. In some embodiments, a primary compressor first compresses the process gas to a pressure of from 10 MPa to 50 MPa and a secondary compressor, which is sometimes designated as hyper compressor, further compresses the process gas to the polymerization pressure of from 110 MPa to 500 MPa.

In some embodiments, the primary compressor and the secondary compressor are multistage compressors. In some embodiments, one or more stages of one or both of these compressors are separated and thereby divided into separated compressors. In some embodiments and in each stage, at least one, alternatively more than one, cylinder is provided. In some embodiments, a hyper compressor has two stages and from 1 to 20, alternatively from 4 to 12 cylinders, in each stage. In some embodiments, the secondary compressor is a hyper compressor. In some embodiments, a series of one primary compressor and one secondary compressor is used for compressing the process gas to the polymerization pressure. In some embodiments, the whole primary compressor is designated as primary compressor. In some embodiments, the one or more first stages of the primary compressor, which compress the recycle gas from the low-pressure product separator to the pressure of the fresh ethylene feed, is designated as the booster compressor and then designate the one or more subsequent stages as the primary compressor. In some embodiments, the booster compressor and the subsequent stages are part of a single apparatus. In some embodiments and after each of the compression stages, the compressed gas mixture is cooled by a compression stage cooler, thereby removing the heat of compression. In some embodiments, the compression stage coolers are operated such that the temperature of the compressed gas mixtures is below 130 °C.

After compression, the compressed process gas is introduced into the polymerization reactor. In some embodiments, the polymerization is carried out in a continuously operated autoclave reactor and the compressed process gas is fed into the autoclave reactor through one or more feeding lines equipped with flow control valves.

In some embodiments, the high-pressure polymerization is carried out at pressures of from 110 MPa to 500 MPa, alternatively from 160 MPa to 350 MPa, alternatively from 200 MPa to 330 MPa, in a tubular reactor. In some embodiments, the high-pressure polymerization is carried out at pressures of from 110 MPa to 300 MPa, alternatively from 120 MPa to 280 MPa, in an autoclave reactor. In some embodiments, the polymerization temperatures are in the range of from 100 °C to 350 °C, alternatively from 180 °C to 350 °C, alternatively from 200 °C to 330 °C, in a tubular reactor. In some embodiments, the polymerization temperatures are in the range of from 110 °C to 320 °C in an autoclave reactor.

In some embodiments, the polymerization of (a) ethylene or (b) ethylene and one or more copolymers is initiated by a free-radical initiator.

In some embodiments, initiators for starting the polymerization are substances that capable of producing radical species under the conditions in the polymerization reactor. In some embodiments, initiators are selected from the group consisting of oxygen, air, azo compounds, and peroxidic polymerization initiators.

In some embodiments, the initiators are organic peroxides, azo compounds, or hydrocarbons which decompose into free radicals. In some embodiments, the organic peroxides are selected from the group consisting of peroxy esters, peroxy ketals, peroxy ketones and peroxycarbonates. In some embodiments, the organic peroxides are selected from the group consisting of di(2-ethylhexyl) peroxydicarbonate, dicyclohexyl peroxydicarbonate, diacetyl peroxydicarbonate, tert-butyl peroxyisopropylcarbonate, di-sec-butyl peroxydicarbonate, di-tert-butyl peroxide, di-tert-amyl peroxide, dicumyl peroxide, 2,5-dimethyl-2,5-di-tert-butylperoxyhexane, tert-butyl cumyl peroxide, 2,5-dimethyl-2,5-di(tert-butylperoxy)hex-3-yne, 1,3-diisopropyl monohydroperoxide, tert-butyl hydroperoxide, didecanoyl peroxide, 2,5-dimethyl-2,5-di(2-ethylhexanoylperoxy)hexane, tert-amyl peroxy-2-ethylhexanoate, dibenzoyl peroxide, tert-butyl peroxy-2-ethylhexanoate, tert-butyl peroxydiethylacetate, tert-butyl peroxy diethylisobutyrate, tert-butyl peroxy-3,5,5-trimethylhexanoate, 1,1-di(tert-butylperoxy)-3,3,5-trimethylcyclohexane, 1,1-di(tert-butylperoxy)cyclohexane, tert-butyl peroxyacetate, cumyl peroxyneodecanoate, tert-amyl peroxyneodecanoate, tert-amyl peroxypivalate, tert-butyl peroxyneodecanoate, tert-butyl permaleate, tert-butyl peroxypivalate, tert-butyl peroxyisononanoate, diisopropylbenzene hydroperoxide, cumene hydroperoxide, tert-butyl peroxybenzoate, methyl isobutyl ketone hydroperoxide, 3,6,9-triethyl-3,6,9-trimethyl-triperoxocyclononane, and 2,2-di(tert-butylperoxy)butane. In some embodiments, the azo compounds are selected from the group consisting of azoalkanes (diazenes), azodicarboxylic esters, azodicarboxylic dinitriles. In some embodiments, the azodicarboxylic dinitrile is azobisisobutyronitrile. In some embodiments, the hydrocarbons, which decompose into free radicals, are referred as C—C initiators. In some embodiments, the C—C initiators are selected from the group consisting of 1,2-diphenyl-1,2-dimethylethane derivatives and 1,1,2,2-tetramethylethane derivatives. In some embodiments, an individual initiator or mixtures of various initiators are used.

In some embodiments, the peroxidic polymerization initiators are selected from the group consisting of 1,1-di(tert-butylperoxy)cyclohexane, 2,2-di(tert-butylperoxy)butane, tert-butyl peroxy-3,5,5-trimethylhexanoate, tert-butyl peroxy benzoate, 2,5-dimethyl-2,5-di(tert-butylperoxy)hexane, tert-butyl cumyl peroxide, di-tert-butyl peroxide and 2,5-dimethyl-2,5-di(tert-butylperoxy)hex-3-yne. In some embodiments, the peroxidic polymerization initiators are selected from the group consisting of tert-butyl peroxy-3,5,5-trimethylhexanoate, di-(2-ethylhexyl)peroxydicarbonate, and tert-butyl peroxy-2-ethylhexanoate.

In some embodiments, the polymerization is carried out by using oxygen, either fed in the form of pure O₂ or as air. In some embodiments and when initiating the polymerization with oxygen, the initiator is first mixed with the ethylene feed and then fed to the reactor. In some embodiments, a stream made from or containing monomer and oxygen is fed to the beginning of the polymerization reactor, to one or more points along the reactor creating two or more reaction zones, or both.

In some embodiments, the process is carried out in an autoclave reactor and the free-radical initiator is introduced into different reaction zones created by baffles attached to the stirrer shaft of the motor in the autoclave reactor. In some embodiments, the free-radical initiator is not introduced into different reaction zones.

In some embodiments, the initiators are used individually or as a mixture, in concentrations of from 0.1 mol/t to 50 mol/t of polyethylene produced, alternatively from 0.2 mol/t to 20 mol/t, in each reaction zone.

In some embodiments, a number of different initiators are used in the process. In some embodiments, the mixture of initiators is made from or containing from two to six, alternatively two, three, or four, different initiators. In some embodiments, a tubular reactor is used and the number of initiators in a mixture is from two to six, alternatively two, three or four. In some embodiments, an autoclave reactor is used and the initiator is a single initiator or a mixture of up to six different initiators, alternatively a mixture of two different initiators. In some embodiments, the free-radical polymerization initiator is a single initiator or a mixture of at least two different initiators. In some embodiments, the zones are fed with the same initiator/mixture of initiators or different initiators/mixture of initiators.

In some embodiments, the mixtures are made from or containing initiators having different decomposition temperatures. In some embodiments, the initiators are used in the dissolved state. In some embodiments, the solvents for dissolving the initiators are selected from the group consisting of ketones and aliphatic hydrocarbons. In some embodiments, the aliphatic hydrocarbons are selected from the group consisting of octane, decane, isododecane and other saturated C₈-C₂₅-hydrocarbons.

In some embodiments, at least part of the process gas is pre-mixed with the one or more free-radical initiators prior to introduction into the polymerization reactor. In some embodiments, pre-mixing the process gas with the initiators provides a more homogenous distribution of the initiator, thereby further providing a more stable operation of the reactor.

In some embodiments, polymerization is initiated by one or more free-radical polymerization initiators. In some embodiments, the initiators are introduced either directly into the polymerization reactor or to the process gas entering reactor by use of a reciprocating phased flow pump with at least two heads. In some embodiments, each head has at least one cylinder. In some embodiments, the use of a phased flow pump facilitates a more stable and less interrupted flow of initiator, thereby resulting in better process control, reactor stability and a high quality product. As previously noted and as used herein, the term “reactor stability” refers to a stable operation achieved without interruption of the reaction, or having a stable temperature profile and no sudden thermal decomposition. In some embodiments, a combination of such a flow pump with a tubular reactor results in an improved initiator flow and a more stable reactor temperature profile, thereby allowing higher temperatures in the reactor and higher production rates.

In some embodiments, the phased flow pump is operated in a manner of overlapping strokes of cylinders of different pump heads, thereby ensuring smooth operation of the reactor and a steady injection of the initiator. In some embodiments, the cylinders of the pump heads are operated such that one cylinder starts moving forward and increases the pressure in the respective pump head before the preceding cylinder has reached the end of the preceding cylinder's stroke and starts decreasing the pressure in the respective pump head.

In some embodiments, the initiator flow is controlled manually. In some embodiments, the initiator flow is adjusted according to a temperature measured inside the reactor. In some embodiments, the phased flow pump is adapted to automatically adjust the initiator flow based on the data corresponding to the temperature measured inside the reactor.

In some embodiments, the process is carried out in a high-pressure polymerization reactor. In some embodiments, the high-pressure polymerization reactor includes a reactor-by-pass for directly transferring at least part of the compressed process gas from the secondary compressor to a high-pressure recycle system. In some embodiments, at least part of the compressed process gas is transferred from the compressor to a high-pressure recycle system, thereby reducing the residence time of the process gas in the reactor. In some embodiments, smaller amount of process gas passing through the reactor uses less energy to bring the process gas up to process temperatures, thereby permitting a reduction of the size of gas heating equipment and heating media.

In some embodiments, this set-up is used and the polymerization is carried out in a continuously operated autoclave reactor.

In some embodiments, the polymerization reactor has one or more reaction zones, alternatively at least one or two reaction zones, alternatively up to 6 reaction zones, alternatively 3 or 4 reaction zones. In some embodiments with an autoclave reactor, the number of reaction zones is defined by the number of agitator baffles on the stirrer.

In some embodiments, the process is carried out in a continuously operated autoclave reactor equipped with a stirrer operated by an electrical motor. In some embodiments, the process gas is additionally used for cooling the motor installed inside the autoclave reactor. In some embodiments, at least part of the process gas is passed along the motor of the stirrer. In some embodiments, the motor shaft avoids process gas leaks, in the absence of a high-pressure seal. In some embodiments, the high-pressure autoclave reactors are stirred reactors. In some embodiments, the high-pressure autoclave reactors have a length-to-diameter ratio in a range from 2 to 30, alternatively from 2 to 20.

In some embodiments, the process further includes a step of discharging the reaction mixture made from or containing (a) ethylene polymer and ethylene or (b) ethylene copolymer, ethylene and one or more comonomers, from the polymerization reactor. In some embodiments, the reaction mixture is discharged through a pressure reduction valve and any unreacted monomer re-introduced into the polymerization process. In some embodiments, the process further includes a step of cooling the discharged reaction mixture.

In some embodiments, the discharged reaction mixture is transferred to at least one product separator for separating the ethylene polymer or ethylene copolymer, thereby separating the polymer from the reaction mixture. In some embodiments, separation is carried out in two or more steps. In some embodiments, separation is carried out in two steps at different pressures. In some embodiments, separation is carried out in a high-pressure product separator and a low-pressure product separator. In some embodiments, the gaseous components of the reaction mixture are cooled and send to the compressor, thereby ensuring efficient gas circulation.

In some embodiments, the high-pressure polymerization is a homopolymerization of ethylene or a copolymerization of ethylene with one or more other monomers, provided that these monomers are free-radically copolymerizable with ethylene under high pressure. In some embodiments, the copolymerizable monomers are selected from the group consisting of α,β-unsaturated C₃-C₈-carboxylic acids, derivatives of α,β-unsaturated C₃-C₈-carboxylic acids, and 1-olefins. In some embodiments, the α,β-unsaturated C₃-C₈-carboxylic acids are selected from the group consisting of maleic acid, fumaric acid, itaconic acid, acrylic acid, methacrylic acid, and crotonic acid. In some embodiments, the derivatives of α,β-unsaturated C₃-C₈-carboxylic acids are unsaturated C₃-C₁₅-carboxylic esters, alternatively esters of C₁-C₆-alkanols, or anhydrides. In some embodiments, the C₃-C₁₅-carboxylic esters are selected from the group consisting of methyl methacrylate, ethyl methacrylate, n-butyl methacrylate, tert-butyl methacrylate, methyl acrylate, ethyl acrylate, n-butyl acrylate, 2-ethylhexyl acrylate, and tert-butyl acrylate. In some embodiments, the anhydrides are selected from the group consisting of methacrylic anhydride, maleic anhydride, and itaconic anhydride. In some embodiments, the 1-olefins are selected from the group consisting of propene, 1-butene, 1-pentene, 1-hexene, 1-octene, and 1-decene. In some embodiments, the comonomers are vinyl carboxylates. In some embodiments, the comonomer is vinyl acetate. In some embodiments, the comonomer is selected from the group consisting of propene, 1-butene, 1-hexene, acrylic acid, n-butyl acrylate, tert-butyl acrylate, 2-ethylhexyl acrylate, vinyl acetate, and vinyl propionate. In some embodiments, the comonomers are derivatives of α,β-unsaturated C₃-C₈-carboxylic acids selected from the group consisting of unsaturated C₃-C₈-carboxylic esters and anhydrides. In some embodiments, the comonomers are 1-olefins selected from the group consisting of propene, 1-butene, and 1-hexane. In some embodiments, the comonomers are selected from the group consisting of acrylic acid, n-butyl acrylate, ter-butyl acrylate, 2-ethylhexyl acrylate and vinyl propriate.

In some embodiments and for copolymerization, the proportion of comonomer or comonomers in the reaction mixture is from 1 to 50% by weight, alternatively from 3 to 40% by weight, based on the amount of monomers, that is, the sum of ethylene and other monomers.

In some embodiments, at least part of the process gas is cooled before entering the polymerization reactor. In some embodiments, an autoclave reactor is used and at least part of the process gas is heated up before entering the autoclave reactor during a start-up phase in which the polymerization reaction is being started. In some embodiments and after the start-up phase, at least part of the process gas is cooled before entering the autoclave reactor. In some embodiments and after the start-up phase, the process gas is cooled before entering the autoclave reactor. In some embodiments, a tubular reactor is used and none of the process gas is cooled before entering the polymerization reactor. In some embodiments, a tubular reactor is used and part of the process gas is cooled before entering the polymerization reactor. In some embodiments, the remaining part of the process gas is heated up before entering the tubular reactor. In some embodiments, the process gas is heated up before entering the tubular reactor. In some embodiments, cooling is effected by conveying the compressed process gas through at least one heat exchanger before introduction into the polymerization reactor.

In some embodiments, the present disclosure provides a high-pressure polymerization apparatus for carrying out the process for preparing ethylene polymers or ethylene copolymers, including:
a compressor or a series of compressors for compressing a reaction mixture made from or containing (a) ethylene or (b) ethylene and one or more comonomers, to a pressure of 110 MPa to 500 MPa, thereby obtaining compressed process gas;
a polymerization reactor for polymerizing (a) ethylene or (b) ethylene and one or more comonomers in the presence of one or more free-radical polymerization initiators at temperatures from 100 to 350 °C, being (a) a continuously operated autoclave reactor with a stirrer driven by an electrical motor or (b) a continuously operated tubular reactor;
at least one feedline equipped for feeding the compressed process gas into the polymerization reactor; and
a reciprocating flow pump with at least two heads, wherein each head having at least one cylinder, for introducing the free-radical polymerization initiators into the polymerization reactor.

In some embodiments, the apparatus further includes
a cooler for cooling a reaction mixture discharged from the polymerization reactor;
at least one separator for separating the ethylene polymer or ethylene copolymer; and
a pelletizer for converting the ethylene polymer or ethylene copolymer into pellets.

In some embodiments, the apparatus further includes a reactor-by-pass for directly transferring compressed process gas from the compressor or series of compressors to a high-pressure recycle system.

In some embodiments, the polymerization reactor is a continuously operated autoclave reactor and the feedlines are equipped with flow control valves.

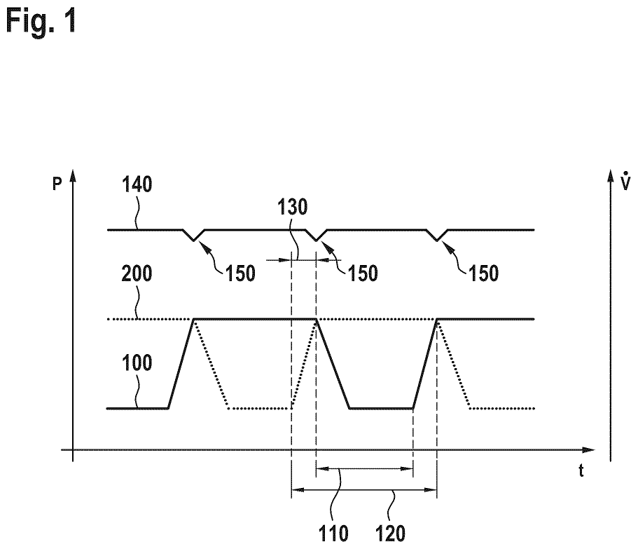

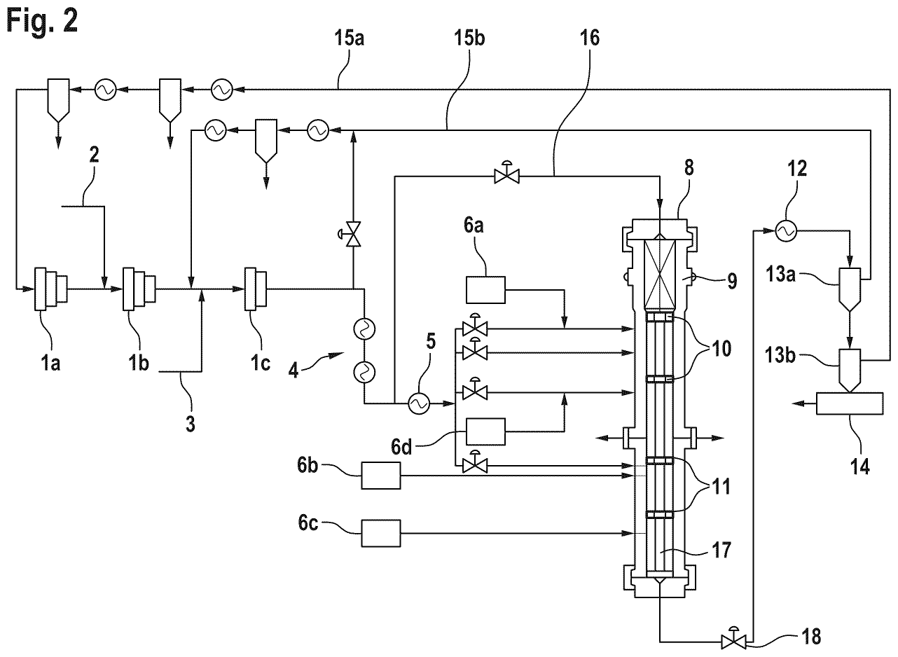

The present disclosure will be described in more detail with reference to FIG. 1 and FIG. 2. The description is not intended to limit the scope or spirit of the present disclosure.

FIG. 1 is a schematic showing a pressure/time diagram of a free-radical initiator feed introduced into the polymerization reactor. In some embodiments, the free-radical initiator is fed either directly into the polymerization reactor or to the process gas stream. The diagram shows the pressure course over time of a first cylinder 100 of a first pump head (solid line) and the pressure course over time of a second cylinder 200 of a second pump head (dotted line). In some embodiments, the phased flow pump used for introducing the initiator feed is cyclically operated. In some embodiments, the cylinders include a plunger, which moves in a suction stroke backwards, increasing an inner volume of the cylinder, thereby initially causing a drop of pressure and subsequently sucking initiator into the inner volume. In a discharge stroke, the plunger moves forward, increasing the pressure inside the inner volume and subsequently pushing the initiator out of the inner volume.

Regarding cylinder 100, represented by the solid line, the cyclic operation is illustrated. Cylinder 100 operates at minimum pressure at a suction stroke. During suction of the initiator into the cylinder 100, the pressure in the first cylinder is low and stays constant, shown by the initial horizontal course of the solid line, due to the cylinder being filled with initiator. Once the suction of initiator into the cylinder is completed, the pressure is increased by movement of a plunger of the cylinder forwards, to a predetermined pressure for injecting the initiator. Thus, the pressure course increases until the predetermined pressure is reached. In some embodiments, the pressure course is increased steadily, until the predetermined pressure is reached. At the predetermined pressure, the initiator is continuously discharged. During the discharge, the pressure is constant at the predetermined pressure level, shown by the horizontal section at higher pressure representing. Once the initiator is completely discharged, the plunger of the cylinder moves backwards leading to a steady decrease of pressure until the minimum pressure is reached starting the new cycle with the suction stroke as described above.

The second cylinder 200 is operated anticyclic to the first cylinder 100 shown with the dotted line. In some embodiments and to further improve the steadiness of the initiator flow, the strokes of the cylinders are phased such that one cylinder reaches the predetermined pressure at the end of the discharge stroke of the other cylinder before starting to reduce the pressure. Consequently and in some embodiments, the suction stroke 110 is shortened compared to the discharge stroke 120 by the phasing 130 schematically shown in FIG. 1. As shown with line 140 depicting the volume flow of the initiator over time, the volume flow remains constant with minimal to no interruptions due to the overlap of strokes and the constant discharge of initiator flows. At the transition between the cylinders responsible for the discharge, minor fluctuations in the flow are depicted by bumps 150.

FIG. 2 is a schematic of a high-pressure polymerization apparatus for carrying out a process for preparing ethylene polymers or ethylene copolymers. In some embodiments, process gas made from or containing (a) a mixture of ethylenically unsaturated monomer or (b) a mixture of ethylenically unsaturated monomer and one or copolymers is compressed in a series of compressors with a booster compressor 1a, a primary compressor 1b and a hyper compressor 1c. In some embodiments, fresh ethylenically unsaturated monomer, chain transfer agents (CTA), comonomer, or a combination thereof is introduced via feed lines 2 and 3, respectively. The compressed process gas is conveyed to a cooler system 4, optionally pre-heated in a start-up heater 5 and introduced into the polymerization reactor 8 via feed lines 16. Part of the process gas is premixed with the polymerization initiator which is provided by pumps 6a to 6d. In some embodiments, the polymerization reactor 8 is a continuously operated autoclave reactor equipped with a motor 9 and baffle plates 11 which divide the reactor into different reaction zones. In some embodiments, the reactor 8 further includes mixing elements 10, installed on a stirrer shaft 17, for mixing the contents of the reactor 8.

In some embodiments, the reaction mixture leaves the polymerization reactor 8 through pressure control valve 18 and passes a post reactor cooler 12. In some embodiments and thereafter, the resulting polymer is separated off from unreacted ethylene and other low molecular weight compounds (monomers, oligomers, polymers, additives, or solvent) by a first separation vessel 13a and a second separation vessel 28, discharged and pelletized via an extruder and granulator 14.

In some embodiments, the ethylene and comonomers, which have been separated off in the first separation vessel 13a, are fed back to the reactor 8 via high-pressure circuit 15b. In some embodiments and in the high-pressure circuit 15b, the gaseous material separated from the reaction mixture is first freed from other constituents in at least one purification stage and then added to the monomer stream between primary compressor 1b and hyper compressor 1c. In some embodiments, the high-pressure circuit 15b separates the solvent from waxes.

In some embodiments, the ethylene, which has been separated off in the second separation vessel 13b, which further includes the major part of the very low molecular weight products of the polymerization (oligomers) and solvent, is worked up in a low-pressure circuit 15a having a plurality of separators with heat exchangers being arranged between each of the separators. FIG. 2 shows two purification stages consisting of heat exchangers and separators. In some embodiments, the process uses one purification stage, alternatively more than two purification stages. In some embodiments, the low-pressure circuit 15a separates oils, solvent and waxes. In some embodiments, the worked up ethylene is first compressed in the booster compressor 1a and returned to the primary compressor 1b.

1. A process for preparing ethylene polymers or ethylene copolymers in a high-pressure polymerization apparatus comprising a polymerization reactor being (a) a continuously operated autoclave reactor with a stirrer driven by an electrical motor or (b) a continuously operated tubular reactor, comprising the steps of:
compressing a reaction mixture comprising (a) ethylene or (b) ethylene and one or more comonomers, to a pressure of 110 MPa to 500 MPa in one or more compressors, thereby obtaining compressed process gas;
feeding the compressed process gas into the polymerization reactor;
introducing one or more free-radical polymerization initiators into the polymerization reactor by a reciprocating phased flow pump with at least two heads, wherein each head having at least one cylinder, and being operable in a manner of overlapping strokes of cylinders of different pump heads; and
polymerizing the ethylene or ethylene and one or more comonomers, in the presence of the free-radical polymerization initiators at temperatures from 100 to 350 °C.

2. The process of claim 1, wherein at least part of the process gas is pre-mixed with the free-radical polymerization initiators prior to introducing the free-radical polymerization initiators into the polymerization reactor.

3. The process of claim 1, wherein the polymerization reactor has one to 6 reaction zones.

4. The process of claim 3, wherein the polymerization reactor is an autoclave reactor and the reaction zones are defined by baffles attached to the stirrer.

5. The process of claim 1, wherein the pump is operated in a manner of overlapping strokes of cylinders of different pump heads.

6. The process of claim 5, wherein the cylinders of the pump heads are operated such that one cylinder starts moving forward before the preceding cylinder has reached the end of the preceding cylinder's stroke.

7. The process of claim 5, wherein the cylinders operate in a suction stroke in which pressure inside the cylinder is reduced, initiator is sucked into the cylinder, or both, and in a discharge stroke, in which pressure inside the cylinder is increased, initiator is discharged out of the cylinder, or both, wherein the suction stroke is shorter than the discharge stroke.

8. The process of claim 7, wherein the suction stroke of the cylinders of one pump head finishes before the discharge stroke of the cylinders of another pump head.

9. The process of claim 1, further comprising the step of:
discharging the reaction mixture comprising (a) ethylene polymer and ethylene or (b) ethylene copolymer, ethylene and one or more comonomers, from the polymerization reactor.

10. The process of claim 1, further comprising a the step of:
cooling the discharged reaction mixture.

11. The process of claim 1, further comprising the step of:
transferring the discharged reaction mixture to at least one product separator for separating the ethylene polymer or ethylene copolymer.

12. The process of any claim 1, further comprising the step of:
converting the resulting ethylene polymer or ethylene copolymer into pellets.

13. The process of claim 1, wherein the one or more comonomers are selected from the group consisting of α,β-unsaturated C₃-C₈-carboxylic acids, derivatives of α,β-unsaturated C₃-C₈-carboxylic acids.

14. A high-pressure polymerization apparatus for carrying out the process of claim 1, comprising:
a compressor or a series of compressors for compressing a reaction mixture comprising (a) ethylene or (b) ethylene and one or more comonomers, to a pressure of 110 MPa to 500 MPa, thereby obtaining compressed process gas;
a polymerization reactor for polymerizing (a) ethylene or (b) ethylene and one or more comonomers, in the presence of one or more free-radical polymerization initiators at temperatures from 100 to 350 °C, being (a) a continuously operated autoclave reactor with a stirrer driven by an electrical motor or (b) a continuously operated tubular reactor;
at least one feedline for feeding the compressed process gas into the reactor; and
a reciprocating phased flow pump with at least two heads, wherein each head comprising at least one cylinder, for introducing the free-radical polymerization initiators into the polymerization reactor.

15. The apparatus of claim 14, further comprising:
a cooler for cooling a reaction mixture discharged from the autoclave reactor;
at least one separator for separating the ethylene polymer or ethylene copolymer; and
a pelletizer for converting the ethylene polymer or ethylene copolymer into pellets.
